(19) United States
(12) Patent Application Publication
(10) Pub. No.: US 2012/0327374 A1
(43) Pub. Date: Dec. 27, 2012

(54) ILLUMINATION APPARATUS AND PROJECTION DISPLAY APPARATUS

(75) Inventors: Hiroshi KITANO, Hyogo (JP); Hiroki SUGIYAMA, Osaka (JP); Shigekazu YAMAGISHI, Osaka (JP)

(73) Assignee: PANASONIC CORPORATION, Osaka (JP)

(21) Appl. No.: 13/529,487

(22) Filed: Jun. 21, 2012

(30) Foreign Application Priority Data
Jun. 23, 2011 (JP) 2011-139079
Jun. 21, 2012 (JP) 2012-139743

(51) Int. Cl. F21V 99/00; G03B 21/14

(52) U.S. Cl. 353/31; 362/235

(57) ABSTRACT

An illumination apparatus that emits first illumination light, second illumination light and third illumination light, the illumination apparatus comprising: a first light source that emits excitation light; a light emitting body that emits the first illumination light by using the excitation light emitted from the first light source; a second light source that emits the second illumination light; a third light source that emits the third illumination light; and a combining unit configured to combine the first illumination light, the second illumination light, and the third illumination light, wherein an optical path length of the second illumination light from the second light source to the combining unit is equal to an optical path length of the third illumination light from the third light source to the combining unit.

### CROSS REFERENCE TO RELATED APPLICATIONS

This application is based upon and claims the benefit of priority from prior Japanese Patent Application No. 2011-139079, filed on Jun. 23, 2011; the entire contents of which are incorporated herein by reference.

### BACKGROUND OF THE INVENTION

1. Field of the Invention

The present invention relates to an illumination apparatus and a projection display apparatus, having a light source and a light emitting body.

2. Description of the Related Art

Conventionally, there is known a projection display apparatus having: a light source; a light valve for modulating light emitted from the light source; and a projection unit for projecting light emitted from the light valve to be enlarged on a screen. The light valve is a digital micro-mirror device (DMD) or a liquid crystal display element, for example.

In recent years, there has also been proposed a technique employing a light emitting diode (LED) light source, a laser diode (LD) light source or the like as a light source. With respect to the LED light source, a speckle noise does not occur, whereas optical energy density is low, and it is difficult to increase luminance of an image. With respect to the LD light source, optical energy density is high, making it possible to increase luminance of an image, whereas a speckle noise caused by high interference property occurs.

Incidentally, there is known a projection display apparatus employing an LED light source or an LD light source as an excitation light source to thereby employ light emitted from a light emitting body. The light emitted by the light emitting body is incoherent; and therefore, even if an LD light source with its own high optical energy density is employed, an occurrence of a speckle noise is restrained.

Here, the projection display apparatus has optical elements such as lenses or mirrors in addition to light sources and light valves. In the projection display apparatus employing light emitting body, there is a room for contrivance with respect to dispositions of optical elements such as lenses or mirrors.

### SUMMARY OF THE INVENTION

An illumination apparatus of a first feature emits first illumination light, second illumination light and third illumination light. The illumination apparatus comprising: a first light source that emits excitation light; a light emitting body that emits the first illumination light by using the excitation light emitted from the first light source; a second light source that emits the second illumination light; a third light source that emits the third illumination light; and a combining unit configured to combine the first illumination light, the second illumination light, and the third illumination light. An optical path length of the second illumination light from the second light source to the combining unit is equal to an optical path length of the third illumination light from the third light source to the combining unit.

In the first aspect, the first illumination light is light of which luminosity is large, in comparison with a luminosity of a respective one of the second illumination light and the third illumination light.

A projection display apparatus of a second feature projects first illumination light, second illumination light, and third illumination light. The projection display apparatus comprising: a first light source that emits excitation light; a light emitting body that emits the first illumination light by using the excitation light emitted from the first light source; a second light source that emits the second illumination light; a third light source that emits the third illumination light; and a combining unit configured to combine the first illumination light, the second illumination light, and the third illumination light, a light valve that modulates the light emitted from the combining unit; and a projection unit configured to project the light emitted from the light valve. An optical path length of the second illumination light from the second light source to the combining unit is equal to an optical path length of the third illumination light from the third light source to the combining unit.

A projection display apparatus of third feature projects red component light, green component light, and blue component light. The projection display apparatus comprising: an LD light source that emits excitation light; a light emitting body that emits the green component light by using the excitation light emitted from the LD light source; a red LED light source that emits the red component light; a blue LED light source that emits the blue component light; a combining unit configured to combine the red component light, the green component light, and the blue component light; a light valve that modulates the light emitted from the combining unit; and a projection unit configured to project the light emitted from the light valve. An optical path length of the red component light from the red LED light source to the combining unit is equal to an optical path length of the blue component light from the blue LED light source to the combining unit.

### BRIEF DESCRIPTION OF THE DRAWINGS

FIG. 1 is a view showing a projection display apparatus 100 according to a first embodiment.

FIG. 2 is a view showing an illumination apparatus 300 according to a first modification.

FIG. 3 is a view showing characteristics of a dichroic mirror 51 according to the first modification.

FIG. 4 is a view showing the illumination apparatus 300 according to a second modification.

FIG. 5 is a view showing a projection display apparatus 100 according to a third modification.

### DETAILED DESCRIPTION OF THE EMBODIMENTS

Hereinafter, an illumination apparatus and a projection display apparatus, according to an embodiment of the present invention, will be described with reference to the drawings. It is to be noted that in the following description of the drawings, same or similar constituent elements are designated by same or like reference numerals.

However, it should be noted that the drawings are schematically shown and the ratio and the like of each dimension are different from the real ones. Accordingly, specific dimensions or the like should be determined in consideration of the following description. Of course, among the drawings, the respective dimensional interrelationships or ratios may differ.

### Outline of the Embodiments

An illumination apparatus according to the embodiments emit first illumination light, second illumination light, and third illumination light. The illumination apparatus is provided with: a first light source that emits excitation light, a light emitting body that emits the first illumination light with use of the excitation light emitted from the first light source; a second light source that emits the second illumination light; a third light source that emits the third illumination light; and a combining unit configured to combine the first illumination light, the second illumination light, and the third illumination light. An optical path length of the second illumination light from the second light source to the combining unit is equal to an optical path length of the third illumination light from the third light source to the combining unit.

In the embodiments, the optical path length of the second illumination light from the second light source to the combining unit is equal to the optical path length of the third illumination light from the third light source to the combining unit. Therefore, optical elements (lenses or mirrors) to be provided on the optical path of the second illumination light and on the optical path of the third illumination light can be easily disposed. In other words, in the case of employing light emitting body, optical elements such as lenses or mirrors can be simply and appropriately disposed.

The embodiments illustrate a case in which the first illumination light is green component light, and the second illumination light and the third illumination light are red component light and blue component light, respectively. However, it is to be noted that the first illumination light is not limited to the green component light, and may be red component light or blue component light. In addition, it should be note that the green component light is light of which luminosity is large in degree, in comparison with that of a respective one of the red component light and blue component light.

### First Embodiment

### (Projection Display Apparatus)

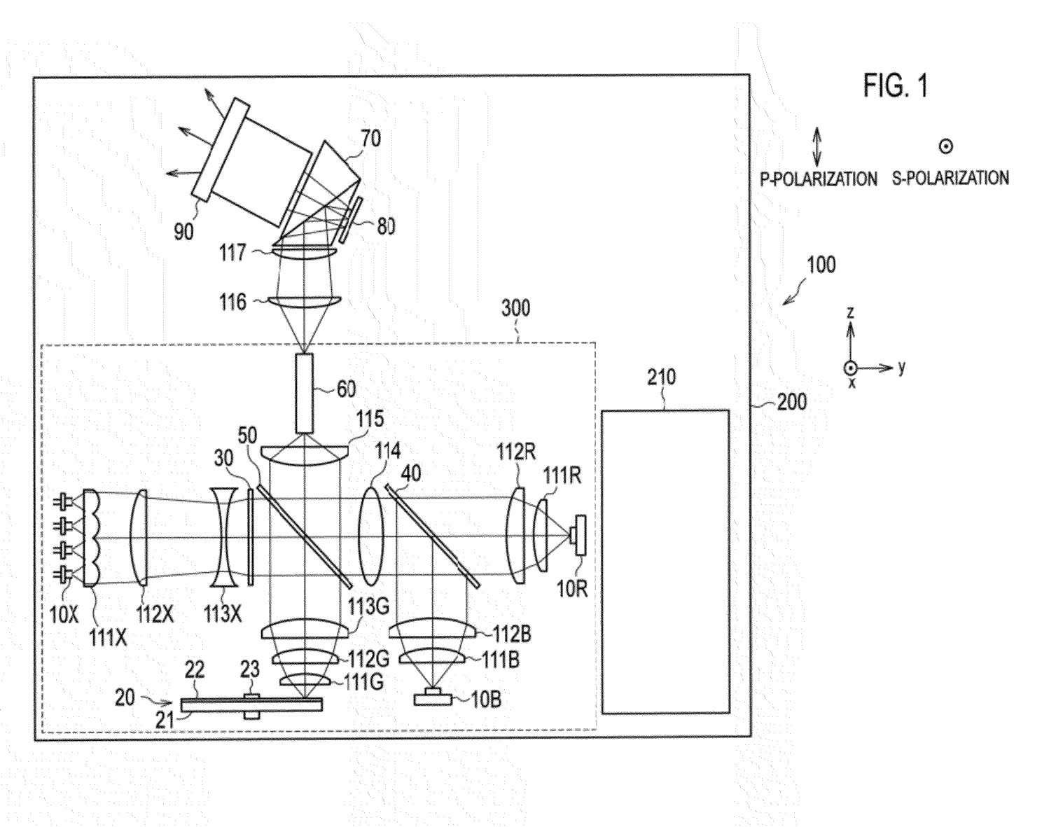

Hereinafter, a projection display apparatus according to a first embodiment will be described. FIG. 1 is a view showing a projection display apparatus 100 according to the first embodiment.

First, the projection display apparatus 100, as shown in FIG. 1, has: a light source 10X; a light source 10R; a light source 10B; a color wheel 20; a diffuser plate 30; a dichroic mirror 40; a dichroic mirror 50; a rod integrator 60; a total internal reflection prism 70; a DMD 80; and a projection unit 90. Here, the projection display apparatus 100 has a casing 200, and the casing 200 has a cooling device 210. Some of the expensive elements that configure the projection display apparatus 100 also configure an illumination apparatus 300.

The light source 10X is an example of an LD light source (or the first light source) that emits excitation light. For example, the light source 10X is a blue semiconductor laser that oscillates at a wavelength approximate to about 445 nm. It is preferable that the light source 10X be made of a plurality of semiconductor lasers in order to provide an illumination apparatus with its own high luminance. For example, a total of 24 semiconductor lasers are disposed on a 4×6 matrix. However, the number of semiconductor lasers is defined in accordance with an output of one semiconductor laser or intensity of light to be output from the illumination apparatus 300.

It is to be noted that the semiconductor lasers that configure the light source 10X are not limited to the blue semiconductor laser that oscillates at a wavelength approximate to 445 nm, for example, and the semiconductor lasers may be a purple semiconductor laser that oscillates at a wavelength approximate to 405 nm or a non-purple semiconductor laser that oscillates at a wavelength of 400 or less.

Here, it is preferable that the semiconductor lasers that configure the light source 10X be disposed so that the light emitted from the semiconductor lasers is adjusted to S polarization shown in FIG. 1. In this manner, it is possible to reflect the light emitted from the light source 10X at its own high efficiency in a dichroic mirror 50 to be described later.

The light source 10R is an example of the second light source (red LED light source) that emits second illumination light (hereinafter, referred to as red component light). For example, the light source 10R is a high output LED with its own dominant wavelength of 625 nm. For example, a light emitting area of the red LED light source that configures the light source 10R is a rectangle of 4 mm×3 mm. For example, a light emitting density per unit time of the red LED light source that configures the light source 10R is about 0.8 W/mm².

The light source 10B is an example of the third light source (blue LED light source) that emits the third illumination light (hereinafter, referred to as blue component light). For example, the light source 10B is a high output LED with its own dominant wavelength of 455 nm. For example, a light emitting area of the blue LED light source that configures the light source 10B, like the red LED light source, is a rectangle of 4 mm×3 mm. For example, a light emitting density per unit time of the blue LED light source that configures the light source 10B is about 1.5 W/mm².

The color wheel 20 has a reflection substrate 21, a light emitting body film 22, and a motor 23.

The reflection substrate 21 reflects light to be incident to the reflection substrate 21 (the light emitted from the light source 10X and light emitted by the light emitting body). Specifically, the reflection substrate 21 is made of a circular plate glass, and on one face of the flat glass, a dichroic coat is provided for reflecting the light incident to the reflection substrate 21 with high efficiency. Specifically, the reflection substrate 21 is disposed in parallel to the xy-plane in the xyz-coordinate system shown in FIG. 1.

The light emitting body film 22 is made of a light emitting body to be coated on the reflection substrate 21. The light emitting body film 22 is provided on a dichroic coat. Specifically, the light emitting body is coated coaxially of an angle of 360 degrees on the reflection substrate 21 so that even if the color wheel 20 rotates, the light emitted from the light source 10X is always irradiated on the light emitting body. The light emitting body may be a phosphor or may be a fluorescent body.

In the first embodiment, the light emitting body is a green phosphor that emits green component light of which a dominant wavelength region is green. As a light emitting body, it is desirable to employ a phosphor that efficiently absorbs blue excitation light and efficiently emit green component light (fluorescence), the phosphor having its own high durability relative to a temperature rise. For example, the phosphor is Y3Al5O12:Ce3+. A main wavelength of the phosphor light emitted by the light emitting body is about 560 nm.

In addition to a cerium-active garnet structure phosphor, green phosphors that are excited with blue laser light with its own wavelength of 445 nm to thereby light-emit green component light (phosphor) include (Ba, Sr)₂SiO₄: Eu²⁺, SrSi₂O₂N₂: Eu²⁺, Ba₃Si₆O₁₂N₂: Eu²⁺, Sr₂Al₃Si₁₃N₂₃: Eu²⁺, β-SiAlON: Eu²⁺ or the like. However, it is to be noted that materials for the green phosphors are not limited in particular.

While a method for producing the light emitting body film 22 is not limited in particular, a printing technique and a molding technique or the like are exemplified. While an appropriate thickness of the light emitting body film 22 varies depending on a type of light emitting body or a method for coating the light emitting body, for example, it is preferable that the thickness be one time or more of an average particle size of the powders that configure the light emitting body. If the thickness of the light emitting body film 22 is too small, the number of light emitting body contributing to wavelength conversion becomes insufficient, thus making it difficult to obtain high wavelength conversion efficiency.

The motor 23 is a motor that rotates the color wheel 20. Specifically, the motor 23 rotates the color wheel 20 with the z-axis being a rotational axis in the xyz-coordinate system shown in FIG. 1. For example, it is preferable that a rotational speed of the color wheel 20 be 1,000 rpm or more in order to restrain an effect of lowered efficiency due to heating of the light emitting body. However, it is to be noted that the rotational speed of the color wheel 20 is not limited in particular.

Here, if a temperature of the light emitting body rises, the wavelength conversion efficiency of the light emitting body lowers. Therefore, in the first embodiment, it is preferable to employ a glass material with its own high thermal conductivity as a material that configures the reflection substrate 21. However, the material that configures the reflection substrate 21 may be aluminum, copper, or a metal consisting essentially thereof. In such a case, mirror surface treatment is applied to a surface of the reflection substrate 21.

While the light emitted by the light emitting body is essentially equally radiated in all directions, in a case where a powdered light emitting body is disposed on a thin film on the reflection substrate 21, it has a light distribution population approximate to Lambertian having a peak in normal direction of a surface on which the light emitting body film 22 is disposed, the population being affected by scattering.

At this time, the light emitting intensity of a backward component (a space into which laser light is caused to be incident, viewed from the light emitting body film 22) is relatively larger; and therefore, it is desirable to collect a light emitting component on only the backward side in order to efficiently take out light emission in a specific direction. Accordingly, in the embodiment, in order to collect light emission only on the backward side, it is preferable to dispose a reflection surface for reflecting light emission (that is, the reflection substrate 21) on the opposite side to the light source 10X as viewed from the light emitting body film 22.

In the first embodiment, it is preferable that the peak optical density per unit time of the green component light (phosphor) emitted by the light emitting body be higher than the light emitting density of a respective one of the red LED light source and the blue LED light source. For example, the peak optical density per unit time of the green component light (phosphor) is about 19 W/mm², for example. As described above, the light emitting density per unit time of the red LED light source is 0.8 W/mm², for example, and the light emitting density per unit time of the blue LED light source is about 1.5 W/mm², for example.

In the first embodiment, it is preferable that a beam radius of the excitation light irradiated on the light emitting body (that is, the light emitted from the light source 10X) be equal to or less than a light emitting area of a respective one of the red LED light source and the blue LED light source. The beam radius used here denotes a diameter of a beam having an intensity of 13.5% of peak intensity when the spatial intensity population of luminous flux of excitation light irradiated on the light emitting body is approximated by a Gaussian population. The beam radius of the excitation light irradiated on the light emitting body is 2 mm, for example. It is to be noted that the light emitting area of a respective one of the red LED light source and the blue LED light source is a rectangle of 4 mm×3 mm, as described above.

Here, the luminous flux of the excitation light irradiated on the light emitting body is a total of spot diameters of the light emitted from a plurality of semiconductor lasers that configure the light source 10X. In the first embodiment, the diffuser plate 30 is provided on an optical path from the light source 10X to the light emitting body; and therefore, it should be note that the spatial intensity population of the excitation light irradiated on the light emitting body can be well approximated by means of the Gaussian population.

It should be note that as the beam radius of the excitation light irradiated on the light emitting body increases, use efficiency of the light emitted by the light emitting body lowers accordingly. Therefore, as described above, it is preferable that the beam radius of the excitation light irradiated on the light emitting body be equal to or less than the light emitting area of a respective one of the red LED light source and the blue LED light source.

However, if the beam radius of the excitation light irradiated on the light emitting body is too small, the wavelength conversion efficiency of the light emitting body lowers. Therefore, it is preferable that the light intensity I and the beam radius w of the excitation light irradiated on the light emitting body should meet a relational formula of I/(πw²)≦50 (W/mm²).

The light source 10R is an example of the second light source (red LED light source) that emits the second illumination light (hereinafter, referred as the red component light). For example, the light source 10R is a high output LED of which a dominant wavelength is 625 nm. The light emitting area of the red LED light source that configures the light source 10R is a rectangle of 4 mm×3 mm. For example, the light emitting density per unit time of the red LED light source that configures the light source 10R is about 0.8 W/mm².

The light source 10B is an example of the third light source (blue LED light source) that emits the third illumination light (hereinafter, referred to as the blue component light). For example, the light source 10B is a high output LED of which a dominant wavelength is 455 nm. The light emitting area of the blue LED light source that configures the light source 10B is a rectangle of 4 mm×3 mm, like the red LED light source. For example, the light emitting density per unit time of the blue LED light source that configures the light source 10B is about 1.5 W/mm².

The diffuser plate 30 diffuses the light emitted from the light source 10X.

The dichroic mirror 40 is disposed so as to be tilted at an angle of 45 degrees with respect to an optical axis of the red component light emitted from the light source 10R and an optical axis of the blue component light. The dichroic mirror 40 has its own properties of high reflection in a wavelength region of the blue component light, and has its own properties of high transmission in a wavelength region of the red component light. That is, the dichroic mirror 40 spatially combines the green component light emitted by the light emitting body, the red component light emitted from the light source 10R, and the blue component light emitted from the light source 10B.

The dichroic mirror 50 is disposed so as to be tilted at an angle of 45 degrees with respect to an optical axis of the light emitted from the light source 10X and an optical axis of the green component light (fluorescence) emitted from the light emitting body. The dichroic mirror 50 has its own properties of high reflection in a wavelength region of the light emitted from the light source 10X, and has its own properties of high transmission in a wavelength region of the green component light (fluorescence) emitted by the light emitting body. That is, the dichroic mirror 50 spatially combines the green component light emitted by the light emitting body, the red component light emitted from the light source 10R, and the blue component light emitted from the light source 10B.

In the first embodiment, the dichroic mirror 50 configures a combining unit configured to combine the red component light, the green component light, and the blue component light.

The rod integrator 60 uniforms the light combined by means of the dichroic mirror 50. The rod integrator 60 is a solid rod made of a transparent material such as a glass. The rod integrator 60 may be a hollow rod of which an interior wall is made of a mirror surface.

Here, it is preferable that Etendue of the green component light that is incident to a light incidence surface of the rod integrator 60 be smaller than Etendue of a respective one of the red component light and the blue component light that are incident to the light incidence surface of the rod integrator 60. It is preferable that Etendue of the red component light that is incident to the light incidence surface of the rod integrator 60 be substantially identical to Etendue of the blue component light that is incident to the rod integrator 60.

The term “Etendue” used herein denotes a product of an area S of the luminous flux that is incident to the light incidence surface of the rod integrator 60 and a three-dimensional angle Ω of the luminous flux that is incident to the light incidence surface of the rod integrator 60. In general, a luminous flux with its smaller Etendue is capable of transmitting light with its higher efficiency through an optical system.

The total internal reflection prism 70 is made of a plurality of prisms. The total internal reflection prism 70 guides the light emitted from the rod integrator 60 to the DMD 80, and guides the light emitted from the DMD 80 to the projection unit 90.

The DMD 80 modulates the light emitted from the rod integrator 60. In detail, the DMD 80 is made of a plurality of micro-mirrors, and the plurality of micro-mirrors is movable. Each of the micro-mirrors is basically equivalent to one pixel. The DMD 80 changes an angle of each of the micro-mirrors, thereby switching whether or not to reflect light to the side of the projection unit 90.

In detail, a tilt of each of the micro-mirrors that configure the DMD 80 varies in accordance with red, green, and blue image input signals. In this manner, the DMD 80 emits the image light modulated with an elapse of time. When the DMD 80 is driven by means of the red image signal, timings of driving the light source 10R and the DMD 80 are controlled so that the red component light is emitted from the light source 10R. Similarly, when the DMD 80 is driven by means of the blue image signal, timings of driving the light source 10B and the DMD 80 are controlled so that the blue component light is emitted from the light source 10B. Similarly, when the DMD 80 is driven by means of the green image signal, timings of driving the light source 10X and the DMD 80 are controlled so that excitation light is emitted from the light source 10X, that is, so that the green component light is emitted by the light emitting body.

The projection unit 90 projects the image light converted by means of the DMD 80, on a projection surface.

The cooling device 210 cools the projection display apparatus 100. Specifically, the cooling device 210 is made of a heat sink and a cooling fan. According to the configuration of the first embodiment, it should be note that the cooling device 210 is disposed so as to be adjacent to the light source 10R, and that a disposition space for the cooling device 210 can be sufficiently allocated. That is, a large sized cooling device 210 can be disposed.

Secondly, the projection display apparatus 100, as shown in FIG. 1, has a plurality of lens groups. Specifically, the projection display apparatus 100 has a lens 111X, a lens 112X, a lens 113X, a lens 111R, a lens 112R, a lens 111G, a lens 112G, a lens 113G, a lens 111B, a lens 112B, a lens 114, a lens 115, a lens 116, and a lens 117.

The lens 111X is a collimation lens adapted to collimate the light emitted from the semiconductor lasers that configure the light source 10X. Each of the lens cells that configure the lens 111X corresponds to a respective one of the semiconductor lasers that configure the light source 10X. That is, the lens 111X is made of a total of 24 lens cells on a 4×6 matrix. In the first embodiment, the lens 111X is a lens array made of the plurality of lens cells. However, it is to be noted that the embodiment is not limited thereto. An independent collimation lens that corresponds to the respective one of the semiconductor lasers configuring the light source 10X may be provided. The lens 112X and the lens 113X are a group of relay lenses that relay the light emitted from the lens 111X.

Here, the luminous flux of the light emitted from the semiconductor lasers is made of a total of 24 beams. The pointing of each of the beams is substantially parallel. The luminous flux diameter of the light emitted from the plurality of semiconductor lasers that configure the light source 10X is reduced by means of transmission of the lens 112X and the lens 113X.

The lens 111R and the lens 112R are collimation lenses that collimate the red component light emitted from the light source 10R. Similarly, the lens 111B and the lens 112B are collimation lenses that collimate the blue component light emitted from the light source 10B. The lens 111R has its own optical properties (material, curvature, and thickness) that are similar to those of the lens 111B, and the lens 112R has its own optical properties that are similar to those of the lens 112B.

The lens 111G, the lens 112G, and the lens 113G function as optical focusing lenses that collect the light reflected by the dichroic mirror 50 (that is, the light emitted from the light source 10X) onto a light emitting body. In addition, the lens 111G, the lens 112G, and the lens 113G function as collimation lenses that collimates the green component light emitted by the light emitting body. While three lenses are employed herein, the functions of these lenses may be achieved by one lens or may be achieved by two lenses.

The lens 114 is a relay lens that relays the light beams (the red component light and the blue component light) that are combined with each other by the dichroic mirror 40.

The lens 115 are an optical focusing lens that optically focuses the light beams (the red component light, the green component light and the blue component light) that are combined with each other by the dichroic mirror 50. The light beams that are optically focused by the lens 115 are incident to the rod integrator 60.

The lens 116 is a relay lens that relays the light emitted from the rod integrator 60. The lens 117 is a field lens that adjusts an orientation of the light emitted from the lens 116. In this manner, an emission surface shape of the rod integrator 60 is transferred to the DMD 80. In other words, the light is optically focused on the DMD 80 with high efficiency and appropriate uniformity.

In the first embodiment, it should be note that the optical path length of the red component light (the second illumination light) from the light source 10R (the second light source) to the dichroic mirror 50 (the combining unit) is equal to the optical path length of the blue component light (the third illumination light) from the light source 10B (the third light source) to the dichroic mirror 50 (the combining unit). The optical path length of the red component light from the light source 10R to the dichroic mirror 50 or the optical path length of the blue component light from the light source 10B to the dichroic mirror 50 is shorter than a total of the optical path of the excitation light from the light source 10X to the color wheel 20 and the optical path length of the green component light from the color wheel 20 to the dichroic mirror 50. The optical path length of the green component light from the color wheel 20 to the dichroic mirror 50 is shorter than the optical path length of the blue component light from the light source 10B to the dichroic mirror 50 or the optical length of the red component light from the light source 10R to the dichroic mirror 50.

In the first embodiment, it should be note that the green component light (the first illumination light) of which luminosity is large in degree, in comparison with that of a respective one of the red component light (the second illumination light) and the blue component light (the third illumination light).

In the first embodiment, the spot diameter of the excitation light irradiated on the light emitting body provided on the color wheel 20 is adjusted in accordance with: the light emitting area of the red LED light source that configure the light source 10R; and the light emitting area of the blue LED light source that configure the light source 10B.

In the first embodiment, it should be note that the illumination apparatus 300 is made of the light source 10X, the light source 10R, the light source 10B, the color wheel 20, the diffuser plate 30, the dichroic mirror 40, the dichroic mirror 50, the rod integrator 60, and required lens groups.

### (Example of Color Balance)

Hereinafter, an example of color balance of the first embodiment will be described. The light emitted from the rod integrator 60 is made of the red component light, the green component light, and the blue component light, and configures preferred white light by employing the projection display apparatus 100.

Here, an example of configuration of the light emitted from the rod integrator 60 will be described with reference to Table 1.

TABLE 1

| | Red | | Green | | Blue | | | |
|---|---|---|---|---|---|---|---|---|
| | component | | component | | component | | Composite | |
| | light | | light | | light | | light | |
| Chromaticity x | 0.702 | | 0.325 | | 0.152 | | 0.285 | |
| Chromaticity y | 0.298 | | 0.624 | | 0.024 | | 0.303 | |
| Energy | 7.7 | W | 19.8 | W | 14.4 | W | 41.9 | W |
| Brightness | 1,340 | lm | 10,580 | lm | 460 | lm | 12,380 | lm |

| | | | | |
|---|---|---|---|---|
| Brightness | 10.8% | 85.5% | 3.7% | 100.0% |
| ratio | | | | |

Each of chromaticity x and chromaticity y is chromaticity of each color light in the xy chromaticity coordinate system. A preferred color area that substantially encompasses an sRGB standard is achieved. In addition, the composite light has its own appropriate chromaticity of white.

Energy is a radiation energy intensity of each color light. Brightness is computed from energy spectra and luminosity properties of each color light. Brightness ratio is a ratio of relative brightness of the brightness of each color light when the brightness of the composite light of three colors is defined to be 1. The brightness ratio is made of a brightness ratio of the red component light of 10% or more and the blue component light of 3% with respect to the composite light.

As described above, an optical configuration of the embodiment is employed, thereby making it possible to provide the illumination apparatus 300 that takes out visible light with its high color rendering properties and high luminance by using a simple method. In addition, it is possible to enhance use efficiency of the green component light (the first illumination light) while the use efficiency of the red component light (the second illumination light) and the blue component light (the third illumination light) are arranged in a well-balanced manner.

### (Functions and Advantageous Effects)

In the first embodiment, the optical path length of the red component light (the second illumination light) from the light source 10R (the second light source) to the dichroic mirror 50 (the combining unit) is equal to the optical path length of the blue light component (the third illumination light) from the light source 10B (the third light source) to the dichroic mirror 50 (the combining unit). Therefore, there can be easily disposed the optical elements (for example, the lens 111R, the lens 112R, the lens 111B, the lens 112B, the lens 114, and the dichroic mirror 40) that are provided on the optical path of the red component (the second illumination light) and on the optical path of the blue path of the light source 10B (the third light source). In other words, in the case of employing a light emitting body, the optical elements such as lenses or mirrors can be easily and appropriately disposed.

### [First Modification]

Hereinafter, a first modification of the first embodiment will be described. Hereinafter, differences from the first embodiment will be mainly described.

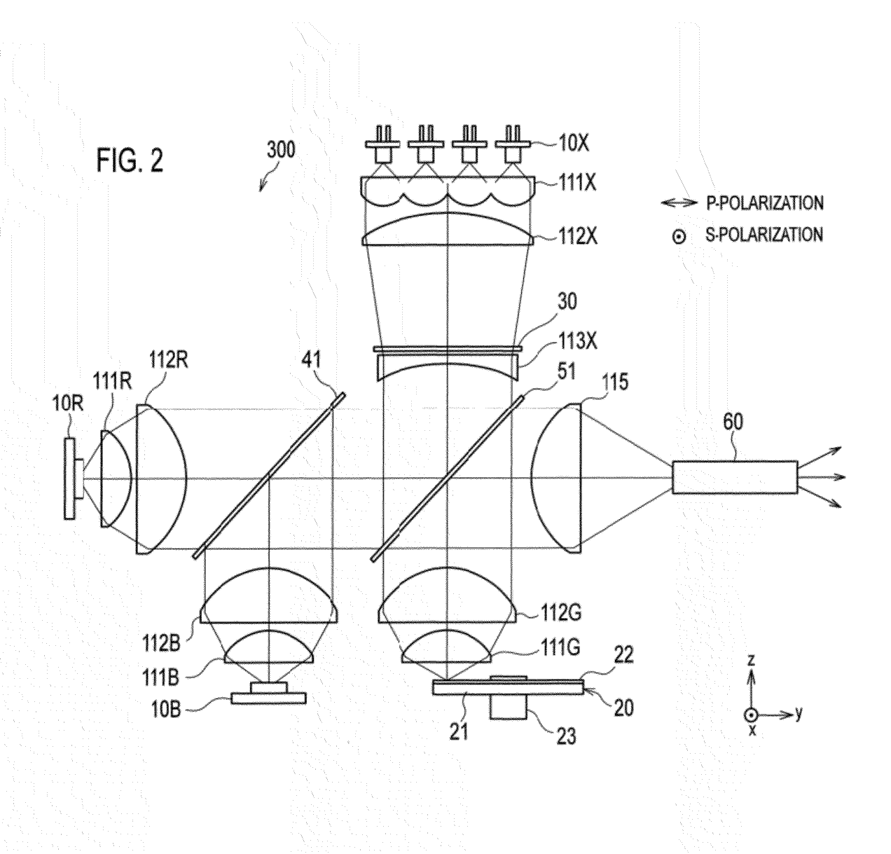

Specifically, in the first modification, as shown in FIG. 2, the dispositions of a light source 10X, a light source 10R, a light source 10B, and a color wheel 20 are different from those of the first embodiment (FIG. 1). It should be note that only an illumination apparatus 300 is shown in FIG. 2.

In detail, as shown in FIG. 2, the illumination apparatus 300 has a dichroic mirror 41 and a dichroic mirror 51 in place of the dichroic mirror 40 and the dichroic mirror 50.

The dichroic mirror 41, like the dichroic mirror 40, is disposed so as to be tilted at an angle of 45 degrees with respect to an optical axis of the red component light emitted from the light source 10R and an optical axis of the blue component light emitted from the light source 10B. The dichroic mirror 41 has its own properties of high transmission in a wavelength region of the red component light, and has its own properties of high reflection in a wavelength region of the blue component light. That is, the dichroic mirror 41 spatially combines the red component light emitted from the light source 10R and the blue component light emitted from the light source 10B with each other.

The dichroic mirror 51 is disposed so as to be tilted at an angle of 45 degrees with respect to the optical axis of the light emitted from the light source 10X and the optical axis of the green component light (fluorescence) emitted by the light emitting body. The dichroic mirror 51 has its own properties of high transmission in a wavelength region of the light emitted from the light source 10X, and has its own properties of high reflection in a wavelength region of the green component light (fluorescence) emitted by the light emitting body. That is, the dichroic mirror 51 spatially combines the green component light emitted by the light emitting body, the red component light emitted from the light source 10R, and the blue component light emitted from the light source 10B.

In the first modification, the dichroic mirror 51 configures a combining unit configured to combine the red component light, the green component light, and the blue component light.

Here, it is preferable that the semiconductor lasers that configure the light source 10X be disposed so that the light emitted from the semiconductor lasers is adjusted to P-polarization shown in FIG. 2. In this manner, it is possible to transmit the light emitted from the light source 10X, with high efficiency in dichroic mirror 51.

Here, in the first modification, as in the first embodiment, a green phosphor of Y₃Al₅O₁₂:Ce³⁺ is employed as a light emitting body. The Y₃Al₅O₁₂:Ce³⁺ has its own excellent properties in obtaining light with its high luminance, whereas the phosphor spectra are a comparatively wide bandwidth. Therefore, in an aspect of color rendering properties, purity of green reproduced by the green component light is insufficient. In the xy-chromaticity coordinate system, if the chromaticity of spectra of the green component light (fluorescence component) is expressed, it follows (x, y)=(0.372, 0.572).

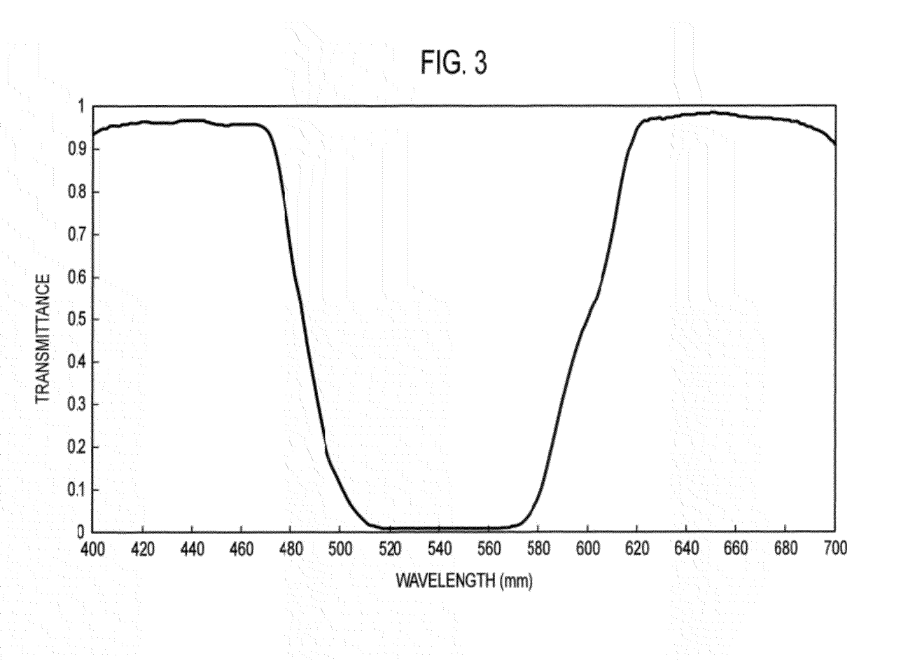

However, from among rays of the green component light (the fluorescence component) emitted by the light emitting body, a fluorescence component on the long wavelength side is eliminated, whereby the purity of green reproduced by the green component light is improved. Specifically, in a case where the light that is incident to the dichroic mirror 51 at an angle of 45 degrees has its own random polarization, the transmission spectra of the dichroic mirror 51 have their properties shown in FIG. 3. As shown in FIG. 3, cutoff wavelengths at which transmittance is 50% are 485 nm and 600 nm. Of all the fluorescence components, the chromaticity (x, y) of reflected light by means of the dichroic mirror 51 is (0.325, 0.624), and the purity of green reproduced by the green component light is improved. That is, in order to allocate a color purity of green reproduced by the green component light, it is desirable that the dichroic mirror 51 should eliminate the light in a wavelength region of 610 nm or more. Further preferably, it is desirable that the dichroic mirror 51 should eliminate the light in a wavelength region of 600 nm or more.

In the first modification as well, it should be note that the optical path length of the red component light (the second illumination light) from the light source 10R (the second light source) to the dichroic mirror 51 (the combining unit) is equal to the optical path length of the blue component light (the third illumination light) from the light source 10B (the third light source) to the dichroic mirror 51 (the combining unit).

### [Second Modification]

Hereinafter, a second modification of the first embodiment will be described. Hereinafter, differences from the first embodiment will be mainly described.

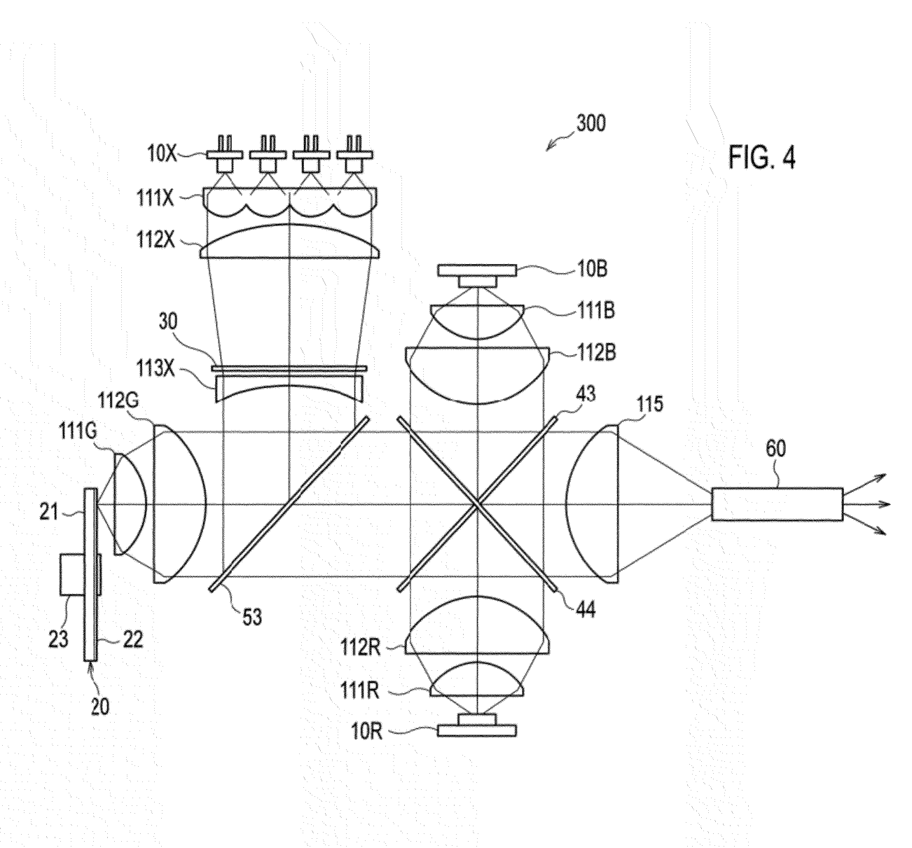

Specifically, in the second modification, as shown in FIG. 4, the dispositions of a light source 10X, a light source 10R, a light source 10B, and a color wheel 20 are different from those of the first embodiment (FIG. 1). It should be note that only an illumination apparatus 300 is shown in FIG. 4.

In detail, as shown in FIG. 4, the illumination apparatus 300 has a dichroic mirror 43, a dichroic mirror 44, and a dichroic mirror 53 in place of the dichroic mirror 40 and the dichroic mirror 50.

The dichroic mirror 43 is disposed so as to be tilted at an angle of 45 degrees with respect to the optical axis of the red component light emitted from the light source 10R and the optical axis of the blue component light emitted from the light source 10B. The dichroic mirror 43 has its own properties of high reflection in a wavelength region of the red component light, and has its own properties of high transmission in a wavelength region other than the wavelength region of the red component light.

The dichroic mirror 44 is disposed so as to be tilted at an angle of 45 degrees with respect to the optical axis of the red component light emitted from the light source 10R and the optical axis of the blue component light emitted from the light source 10B. The dichroic mirror 44 has its own properties of high reflection in a wavelength region of the blue component light, and has its own properties of high transmission in a wavelength region other than the wavelength region of the blue component light.

Here, the dichroic mirror 43 and the dichroic mirror 44 spatially combines the green component light emitted by the light emitting body, the red component light emitted from the light source 10R, and the blue component light emitted from the light source 10B.

In the second modification, the dichroic mirror 43 and the dichroic mirror 44 configure a combining unit configured to combine the red component light, the green component light, and the blue component light. The dichroic mirror 43 and the dichroic mirror 44 may configure dichroic prisms.

The dichroic mirror 53 is disposed so as to be tilted a an angle of 45 degrees with respect to the optical axis of the light emitted from the light source 10X and the optical axis of the green component light (fluorescence) emitted by the light emitting body. The dichroic mirror 53 has its own properties of high reflection in a wavelength region of the light emitted from the light source 10X, and has its own properties of high transmission in a wavelength region of the green component light (fluorescence) emitted by the light emitting body.

In the second modification as well, it should be note that an optical path length of the red component light (the second illumination light) from the light source 10R (the second light source) to the dichroic mirror 43 and the dichroic mirror 44 (the combining unit) is equal to an optical path length of the blue component light (the third illumination light) from the light source 10B (the third light source) to the dichroic mirror 43 and the dichroic mirror 44 (the combining unit).

However, in the second modification, an optical path length of the green component light from a color wheel 20 to the dichroic mirror 50 is greater than an optical path length of the red component light from the light source 10R to the dichroic mirror 50 or an optical path length of the blue component light from the light source 10B to the dichroic mirror 50. Therefore, the second modification is preferred in the case of increasing a rate of the red component light and the blue component light in the composite light (white light).

In the second modification, from among rays of the green component light (the fluorescence components) that passes through the dichroic mirror 53, a fluorescence component on a long wavelength is eliminated by means of the dichroic mirror 43 having its own properties of high reflection in the wavelength region of the red component light.

### [Third Modification]

Hereinafter, a third modification of the first embodiment will be described. Hereinafter, differences from the first embodiment will be mainly described.

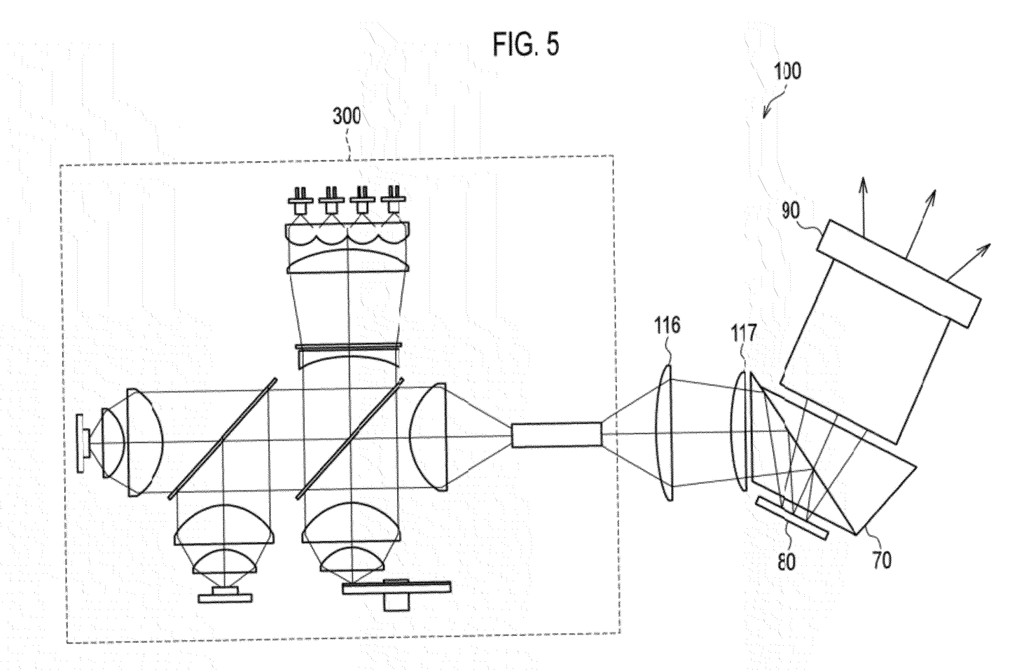

Specifically, in the third embodiment, as shown in FIG. 5, the illumination apparatus 300 shown in the first modification is applied to a projection display apparatus 100. It is to be noted that the projection display apparatus 100 of the third embodiment is similar to that of the first embodiment, and a detailed description thereof is not given here.

### Other Embodiments

While the present invention has been described by way of the foregoing embodiments, it should not be understood that the statements and drawings forming part of this disclosure limit the present invention. From this disclosure, a variety of substitutive embodiments, examples, and operational techniques would have been self-evident to one skilled in the art.

The embodiments have illustrated a case of employing the DMD 80 as a light valve. However, it is to be noted that the embodiments are not limited thereto. The light valve may be a liquid crystal panel of reflection type or may be a liquid crystal panel of transmission type.

What is claimed is:

1. An illumination apparatus that emits first illumination light, second illumination light and third illumination light, the illumination apparatus comprising:
a first light source that emits excitation light;
a light emitting body that emits the first illumination light by using the excitation light emitted from the first light source;
a second light source that emits the second illumination light;
a third light source that emits the third illumination light; and
a combining unit configured to combine the first illumination light, the second illumination light, and the third illumination light, wherein
an optical path length of the second illumination light from the second light source to the combining unit is equal to an optical path length of the third illumination light from the third light source to the combining unit.

2. The illumination apparatus according to claim 1, wherein
the first illumination light is light of which a luminosity is large, in comparison with a luminosity of a respective one of the second illumination light and the third illumination light.

3. A projection display apparatus that projects first illumination light, second illumination light, and third illumination light, said projection display apparatus comprising:
a first light source that emits excitation light;
a light emitting body that emits the first illumination light by using the excitation light emitted from the first light source;
a second light source that emits the second illumination light;
a third light source that emits the third illumination light; and
a combining unit configured to combine the first illumination light, the second illumination light, and the third illumination light,
a light valve that modulates the light emitted from the combining unit; and
a projection unit configured to project the light emitted from the light valve, wherein
an optical path length of the second illumination light from the second light source to the combining unit is equal to an optical path length of the third illumination light from the third light source to the combining unit.

4. A projection display apparatus that projects red component light, green component light, and blue component light, said projection display apparatus comprising:
an LD light source that emits excitation light;
a light emitting body that emits the green component light by using the excitation light emitted from the LD light source;
a red LED light source that emits the red component light;
a blue LED light source that emits he blue component light;
a combining unit configured to combine the red component light, the green component light, and the blue component light;
a light valve that modulates the light emitted from the combining unit; and
a projection unit configured to project the light emitted from the light valve, wherein
an optical path length of the red component light from the red LED light source to the combining unit is equal to an optical path length of the blue component light from the blue LED light source to the combining unit.
